(19) United States
(12) Patent Application Publication
(10) Pub. No.: US 2008/0280560 A1
(43) Pub. Date: Nov. 13, 2008

(54) METHOD AND SYSTEM OF PLACING A RFID TAG IN A CONTINUOUS TRANSMISSION MODE

(75) Inventor: JOHN R. TUTTLE, BOULDER, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: MICRON TECHNOLOGY, INC., BOISE, ID (US)

(21) Appl. No.: 11/746,244

(22) Filed: May 9, 2007

(51) Int. Cl. H04B 7/00

(52) U.S. Cl. 455/41.2; 340/540

(57) ABSTRACT

Method and system of placing a RFID tag in a continuous transmission mode. At least some of the illustrative embodiments are methods comprising sending a command from a radio frequency identification (RFID) reader to a first RFID tag, and then transmitting continuously by the first RFID tag based on the command. Other illustrative embodiments are RFID tags comprising a tag antenna, and a RFID circuit coupled to the tag antenna. The RFID circuit is configured to, responsive to a first command from a RFID reader, repeatedly transmit a message to the RFID reader.

### BACKGROUND

1. Field

At least some of the various embodiments are directed to commands that are sent to, and responses received from, radio frequency identification (RFID) tags.

2. Description of the Related Art

In many circumstances, a radio frequency identification (RFID) reader may be in the presence of a plurality of RFID tags. If the RFID reader does not already know the identity of a particular RFID tag, the RFID reader and RFID tags may perform a series of communications to isolate the particular RFID tag to which the RFID reader is to communicate (also known as selecting the RFID tag). Once selected, communication between the RFID reader and the selected RFID tag is initiated by the RFID reader. To the extent the selected RFID tag responds to a communication from the RFID reader, in at least one conventional system the RFID tag responds only once. If a RFID reader wants or needs multiple responses from the RFID tag (even with the same data), the RFID reader of this system is forced to send a command to trigger each and every response from the RFID tag.

### BRIEF DESCRIPTION OF THE DRAWINGS

For a detailed description of various embodiments, reference will now be made to the accompanying drawings in which:

FIG. 1 shows a radio frequency identification (RFID) system in accordance with at least some embodiments; and

FIG. 2 shows a method in accordance with at least some embodiments.

### NOTATION AND NOMENCLATURE

Certain terms are used throughout the following description and claims to refer to particular system components. As one skilled in the art will appreciate, design and manufacturing companies may refer to the same component by different names. This document does not intend to distinguish between components that differ in name but not function. In the following discussion and in the claims, the terms “including” and “comprising” are used in an open-ended fashion, and thus should be interpreted to mean “including, but not limited to . . . ”

Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system,” “subsystems” within the system, a radio frequency identification (RFID) tag, a RFID reader, or any other device comprising one or more components.

The terms “continuous” and “continuously” in describing an action (e.g., transmitting data) shall mean without significant pause. Pauses between data bits, pauses as part of the communication protocol (e.g., between groups of data or words) and pauses at the transition between the end of a first burst and the beginning of a next burst (whether the data of the bursts are the same or different) shall not obviate that the action is “continuous” or performed “continuously.” For example, a RFID tag in accordance with some embodiments may repeatedly send a block of data in response to a single command from a RFID reader, and such transmission shall be considered “continuous” or transmitted “continuously.”

### DETAILED DESCRIPTION OF DISCLOSED EMBODIMENTS

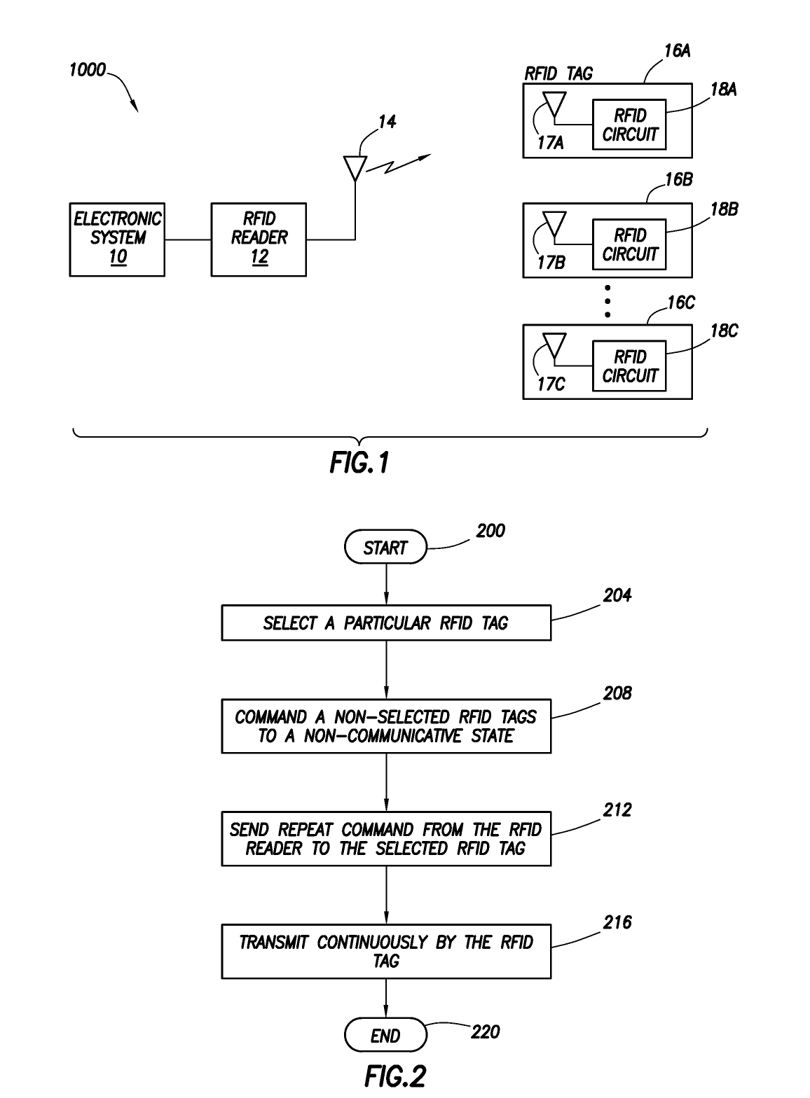

FIG. 1 illustrates a system 1000 in accordance with at least some embodiments. In particular, system 1000 comprises an electronic system 10 (e.g., a computer system) coupled to a radio frequency identification (RFID) reader 12. The RFID reader 12 may be equivalently referred as an interrogator. By way of antenna 14, the RFID reader 12 communicates with one or more RFID tags 16A-16C proximate to the RFID reader (i.e., within communication range).

Considering a single RFID tag 16A (but the description equally applicable to all the RFID tags 16), the communication sent by the RFID reader 12 is received by tag antenna 17A, and passed to the RFID circuit 18A. If the communication from the RFID reader triggers a response, the RFID circuit 18 sends to the RFID reader 12 the response (e.g., a tag identification value, or data held in the tag memory) using the tag antenna 17A. The RFID reader 12 passes data obtained from the various RFID tags 16 to the electronic system 10, which performs any suitable function. For example, the electronic system 10, based on the data received from the RFID tags 16, may allow access to a building or parking garage, note the entrance of an employee to a work location, direct a parcel identified by the RFID tag 16 down a particular conveyor system, or inventory products in a shopping cart for purposes of checkout and payment.

There are several types of RFID tags operable in the illustrative system 1000. For example, RFID tags may be active tags, meaning each RFID tag comprises its own internal battery or other power source. Using power from the internal power source, an active RFID tag monitors for signals from the RFID reader 12. When an interrogating signal directed to the RFID tag is sensed, the tag response may be tag-radiated radio frequency (RF) power (with a carrier modulated to represent the data or identification value) using power from the internal battery or power source. A semi-active tag may likewise have its own internal battery or power source, but a semi-active tag remains dormant (i.e., powered-off or in a low power state) most of the time. When an antenna of a semi-active tag receives an interrogating signal, the power received is used to wake or activate the semi-active tag, and a response (if any) comprising an identification value is sent by modulating the RF backscatter from the tag antenna, with the semi-active tag using power for internal operations from its internal battery or power source. In particular, the RFID reader 12 and antenna 14 continue to transmit power after the RFID tag is awake. While the RFID reader 12 transmits, the tag antenna 17 of the RFID tag 16 is selectively tuned and de-tuned with respect to the carrier frequency. When tuned, significant incident power is absorbed by the tag antenna 17. When de-tuned, significant power is reflected by the tag antenna 17 to the antenna 14 of the RFID reader 12. The data or identification value modulates the carrier to form the reflected or backscattered electromagnetic wave. The RFID reader 12 reads the data or identification value from the backscattered electromagnetic waves. Thus, in this specification and in the claims, the terms “transmitting” and “transmission” include not only sending from an antenna using internally sourced power, but also sending in the form of backscattered signals.

A third type of RFID tag is a passive tag, which, unlike active and semi-active RFID tags, has no internal battery or power source. The tag antenna 17 of the passive RFID tag receives an interrogating signal from the RFID reader, and the power extracted from the received interrogating signal is used to power the tag. Once powered or “awake,” the passive RFID tag may accept a command, send a response comprising a data or identification value, or both; however, like the semi-active tag the passive tag sends the response in the form of RF backscatter.

There may be times in the use of RFID readers and RFID tags where an RFID reader needs the RFID tag to transmit multiple copies of data, or just to transmit multiple times without regard to the data sent. For example, when an RFID tag is at the edge of communication range with the RFID reader, random bits within the response transmitted by the RFID tag to the RFID reader may be garbled, and if the data is transmitted multiple times by the RFID tag, the data received by the RFID reader may be compared and the errors corrected. Likewise, in situations where the RFID reader attempts to determine spatial location and/or movement of an RFID tag, continuous transmission by the RFID tag may be helpful in that endeavor. However, existing protocols that govern communication between an RFID reader and an RFID tag (e.g., Radio-Frequency Identity Protocols Class-1, Generation-2 UHF RFID Version 1.0.9 (also known as the EPC Global RFID Air Interface) promulgated by EPCglobal Inc.) limit transmission by RFID tags only to direct responses to commands from the RFID reader. The limitation to a command/response format is dictated, to some extent, by the limited internal power of RFID tags, especially active and semi-active tags.

In accordance with the various embodiments disclosed herein, RFID readers are configured to send, and the RFID tags are configured to receive and act in response to, a new command termed herein the “Repeat” command. When the RFID reader needs a particular RFID tag to transmit on a continuous basis (e.g., in an attempt to receive a message from a RFID tag on the edge of its communication range, or to determine the location or movement of the RFID tag), the RFID reader sends the “Repeat” command to the RFID tag. The RFID tag, in turn, repeatedly transmits data to the RFID reader. In the case of active and semi-active RFID tags, the RFID reader may merely “listen” for the responses. For passive and semi-active tags, the RFID reader transmits a continuous wave signal, while the passive or semi-active tag backscatters the data.

FIG. 2 illustrates a method in accordance with at least some embodiments. In particular, the method starts (block 200) and proceeds to selecting a particular RFID tag (block 204). Selecting a particular RFID tag may take many forms. In embodiments operated under the illustrative RFID Air Interface specification mentioned above, selecting a RFID tag may involve broadcasting a “Query” command, which forces each RFID tag in communication range to generate a random number and place the random number in a slot counter register of the RFID tag. Under the RFID Air Interface protocol, an RFID tag may only communicate if its slot counter value is zero; thus, the RFID reader communicates with the RFID tag whose slot counter is zero. Once communication with the particular RFID tag is complete, or if no RFID tag had a zero value slot counter, the RFID reader issues a “QueryRep” command, which triggers each RFID tag to decrement its respective slot counter.

With respect to the EPC Global RFID Air Interface protocol, consider a situation where two RFID tags exist within the transmission range of a RFID reader, and that there are four possible slots for communication. Upon receiving the “Query” command from the RFID reader, each RFID tag generates a random number between 0 and 4 (in this example), and places the number in its slot counter register. Further consider that a first RFID tag, after random number generation, has slot counter value of 1 and the second RFID tag has a slot counter value of 3. Because neither RFID tag has a slot counter value of 0, neither RFID tag communicates to the RFID reader. The RFID reader, in turn, issues a “QueryRep” command, which forces the RFID tags to decrement their slot counter values. After the “QueryRep” command, the first RFID tag has slot counter of 0, and the second RFID tag has slot counter of 2. Thus, the first RFID tag has been singulated, and the RFID reader may communicate with the first RFID tag. Other mechanism to determine the identity and/or select a particular RFID tag may be equivalently used.

In embodiments where the selection process itself does not place other RFID tags in a non-communicative state (e.g., the RFID Air Interface protocol), in some embodiments the illustrative method herein may proceed to commanding non-selected RFID tags to a non-communicative state (block 208). However, in other embodiments the communicative state of non-selected RFID tags may be unaffected by the selection process and/or otherwise remain unchanged.

Regardless of the precise mechanism to select a particular RFID tag, the next step in the illustrative process is to send a command from the RFID reader to the selected RFID tag (block 212), such as a “Repeat” command. The “Repeat” command may take many forms. In embodiments where the non-selected RFID tags are still communicative, the “Repeat” (e.g., a value predetermined as between the RFID reader and RFID tag to represent “Repeat”) command may also comprise a value that identifies the selected RFID tag (i.e., a tag identifier). Thus, though all the RFID tags that receive the “Repeat” command and are in a state where a response is possible, only the RFID tag identified by the tag identifier fulfills the request of the command. Thus, in some embodiments the RFID tag decodes the command, and determines whether the command is directed to the RFID tag. In embodiments where non-selected RFID tags are placed in a non-communicative state (either by the selection process or by directed command), the “Repeat” command may be sent without tag identifiers. In yet still other embodiments, the “Repeat” command comprises a value indicative of the length of time for the RFID tag to transmit, or a value indicative of the number of bursts to send.

In response to the “Repeat” command, the RFID tag transmits continuously (block 216), and the illustrative method ends (block 220). In embodiments where the “Repeat” command does not comprise a value indicative of how long to transmit or number of bursts, the RFID tag is configured to transmit for a predetermined length of time (e.g., 100 milliseconds) or a predetermined number of bursts (e.g., 10 bursts). In embodiments where the “Repeat” command comprises a value indicative of length of time or number of bursts, then the RFID tag transmits for the designated length of time or number of bursts. In some embodiments, the RFID tag may have hard-coded the length of time to transmit or the number of bursts, and the RFID tag uses the hard coded values when no parameter accompanies the “Repeat” command, and uses the length/number when that data accompanies the “Repeat” command.

The data continuously transmitted by the RFID tag in response to the “Repeat” command may likewise take many forms. For RFID readers and RFID tags operated consistent with the RFID Air Interface specification, the RFID tag passes a tag identifier or “handle” to the RFID reader as part of the isolation process, where the tag identifier is a random number newly generated for each isolation procedure. Thus, in response to the “Repeat” command in some embodiments the RFID tag continuously transmits the tag identifier. In other embodiments, the RFID tag may continuously transmit any data contained within the RFID tag memory, such as the electronic product code associated with the RFID tag, or user specific data written to the RFID tag by any means. In yet still other embodiments, particularly those where the continuous presence of the return signal is desired but the precise content of the return signal is not as important (e.g., location and movement determinations), the RFID tag may generate a plurality of random numbers and sequentially transmit each random number.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
sending a command from a radio frequency identification (RFID) reader to a first RFID tag; and then
transmitting continuously by the first RFID tag based on the command.

2. The method according to claim 1 wherein transmitting further comprises transmitting by the first RFID tag for a predetermined period of time.

3. The method according to claim 2 wherein sending the command further comprises sending the command comprising a value indicative of the predetermined period of time.

4. The method according to claim 1 wherein transmitting further comprises repetitively transmitting a predetermined number of data value bursts by the first RFID tag.

5. The method according to claim 4 wherein sending the command further comprises sending the command comprising a value indicative of the predetermined number of bursts.

6. The method according to claim 1 further comprises transmitting one or more selected from the group consisting of: an electronic product code stored in the first RFID tag; a random number; and a value from memory of the first RFID tag.

7. The method according to claim 1 wherein sending the command further comprises sending the command comprising a value identifying the first RFID tag.

8. The method according to claim 1 further comprising causing a second RFID tag to be in a non-communicative state.

9. The method according to claim 1 further comprising sending a command to silence a second RFID tag.

10. The method according to claim 1 further comprising:
receiving the command by a second RFID tag;
decoding the command to determine whether to command is directed to the second RFID tag.

11. A system comprising:
a reading antenna;
a radio frequency identification (RFID) reader coupled to the reading antenna;
wherein the RFID reader is configured send a command to a first RFID tag, the command places the first RFID tag in a repeating transmission mode.

12. The system according to claim 11 wherein when the RFID reader sends the command the RFID reader is further configured to send a value indicative of a length of time which the first RFID tag remains in the repeating transmission mode.

13. The system according to claim 11 wherein when the RFID reader sends the command the RFID reader is further configured to send a value indicative of a number of times the first RFID tag should repeat transmission.

14. The system according to claim 11 wherein, prior to sending the command, the RFID reader is configured to determine identity of the first RFID tag.

15. The system according to claim 11 wherein the RFID reader is configured to send the command comprising tag identifier that identifies the first RFID tag.

16. The system according to claim 11 wherein the RFID reader is further configured to communicatively isolate the first RFID tag from among a plurality of RFID tags.

17. The system according to claim 16 wherein the RFID reader is further configured to force a slot counter of other RFID tags to a non-zero value.

18. A radio frequency identification (RFID) tag comprising:
a tag antenna;
a RFID circuit coupled to the tag antenna;
wherein the RFID circuit is configured to, responsive to a first command from a RFID reader, repeatedly transmit a message to the RFID reader.

19. The RFID tag according to claim 18 wherein the RFID tag is further configured to repeatedly transmit the message for a predetermined period of time.

20. The RFID tag according to claim 18 wherein the RFID tag is further configured to repeatedly transmit the message for period of time indicated by the command.

21. The RFID tag according to claim 18 wherein the RFID tag is further configured to transmit the message a predetermined number of times.

22. The RFID tag according to claim 18 wherein the RFID tag is further configured to transmit the message a predetermined number of times indicated by the command.

23. The RFID tag according to claim 18 wherein the RFID tag is configured to repeatedly transmit the message being one or more selected from the group consisting of: an electronic product code stored in the RFID tag; a random number; and a value from memory of the RFID tag.

24. The RFID tag according to claim 18 wherein the RFID tag is further configured to, responsive to a second command from a RFID reader, refrain from transmitting.
